(19) United States
(12) Patent Application Publication
(10) Pub. No.: US 2003/0225622 A1
(43) Pub. Date: Dec. 4, 2003

(54) Method and system for entering orders of customers

(76) Inventor: William T. Doan, New Hope, PA (US)

Correspondence Address: HOWSON AND HOWSON, ONE SPRING HOUSE CORPORATION CENTER, BOX 457, 321 NORRISTOWN ROAD, SPRING HOUSE, PA, 19477, US

(21) Appl. No.: 10/156,599

(22) Filed: May 28, 2002

(51) Int. Cl. G06F 17/60

(52) U.S. Cl. 705/15; 705/26

(57) ABSTRACT

A method and system for entering an order into an onsite computer-based sales management system of a restaurant. A communication link is established between an offsite employee and an order-placing talk box at the restaurant. The communication link is utilized for two-way voice communication so that a food order can be taken from a customer located at the restaurant by the offsite employee. A data communication link is utilized by the offsite employee to enter the order into the onsite computer-based sales management system which facilitates food preparation, fee collection, and the recording of sales. Preferably, the offsite employee utilizes a personal computer to accomplish the stated functions, the communication links are provided via the Internet, and the customer is located within a vehicle adjacent the restaurant when placing his/her order.

### FIELD OF THE INVENTION

The present invention relates to a method and system for taking and processing sales of items at stores, restaurants, and like businesses, and more particularly, the present invention relates to a method and system for taking food orders from customers located at drive-through or other stations of a restaurant which enables efficient use of restaurant personnel and floor space.

### BACKGROUND OF THE INVENTION

Drive-through lanes are commonly used at restaurants, such as so-called “fast food” restaurants, for handling take-out orders of customers located in vehicles positioned adjacent an exterior of the restaurant. In the conventional system, an employee of the restaurant that is physically located within the restaurant communicates with the customer to take the customer's order. A two-way communication link is provided between a drive-through order-placing station and the employee. This link typically extends a distance less than the length of the restaurant and is provided by a hard-wired connection or a partially hard-wired/partially wireless communication path. The employee typically enters the customer's order into an electronic point of sale (POS) register which is connected by hard wire to an electronic computer-based sales management system within the restaurant. Food preparation, payment collection, and sales recording functions are readily performed after the order is entered into the system.

Examples of ordering systems for processing drive-through take-out orders at fast food restaurants are disclosed by U.S. Pat. No. 5,907,275 issued to Battistini et al., U.S. Pat. No. 6,003,015 issued to Kang et al., and U.S. Pat. No. 5,864,824 issued to Iguchi et al. In addition, examples of point of sale registers and computer-based restaurant management systems are disclosed by U.S. Pat. No. 5,510,979 issued to Moderi et al., U.S. Pat. No. 5,838,798 issued to Stevens, III, U.S. Pat. No. 4,388,689 issued to Hayman et al., and U.S. Pat. No. 5,602,730 issued to Coleman et al.

In the above referenced conventional system, the employee handling the drive-through take-out orders is required to be present within the restaurant to perform the order-taking function. The employee's work station requires an amount of floor space within the restaurant, and the space available is typically cluttered, shared, and/or is otherwise insufficient for an employee that may require additional space for personal and/or physical reasons. Thus, an improved system is required which maximizes efficient use of floor space within a restaurant and which permits employees having various physical conditions to function in such positions.

Various U.S. patents have suggested improvements to conventional ordering systems by providing customer self-ordering systems. For example, see U.S. Pat. No. 4,128,757 issued to Gamer, Jr., U.S. Pat. No. 5,235,509 issued to Mueller et al., U.S. Pat. No. 5,128,862 issued to Mueller, and U.S. Pat. No. 4,567,359 issued to Lockwood for a disclosure of customer self-ordering systems for customers located within a restaurant. U.S. Pat. No. 6,366,220 issued to Elliot and U.S. Patent Application Publication No. 2002/0013730 of Bigus disclose drive-through customer self-ordering systems utilizing RF tags or portable wireless receivers. In addition, U.S. Pat. No. 5,845,263 issued to Camaisa et al. and U.S. Pat. No. 5,991,739 issued to Cupps et al. disclose customer self-ordering via the Internet for home delivery of purchased items.

While customer self-ordering systems provide some advantages, they also provide a disadvantage in that most customers prefer to deal directly with a human order-taker rather than an electronic device. This is particularly the case for customers that are unfamiliar with using various electronic devices, do not possess the required devices, or infrequently place such orders.

Another example of a food ordering system is disclosed by U.S. Pat. No. 4,797,818 issued to Cotter. According to the Cotter system, a plurality of related pizza restaurants located in an extended geographical region provide a single telephone number to their customers for use in ordering pizzas to be delivered. A telephone attendant is located at an offsite location relative to the restaurants and speaks directly with customers to take the customers' call-in food orders. Thereafter, the attendant communicates the order to the appropriate restaurant that is located geographically closest to the customer location, and the selected restaurant prepares, delivers and receives payment for the food.

Although the aforementioned ordering systems may function satisfactorily for their intended purposes, there exists a need for an improved method and system for the efficient handling of take-out orders of customers located at drive-through or other ordering stations at fast food restaurants and like stores. The novel system and method should provide employment opportunities to a valuable previously untapped source of employees, should provide an ordering format favored by customers, and should be cost effective to implement by the restaurant or store. Preferably, the system should provide two-way voice communication between a customer and a restaurant employee as provided in conventional systems. However, unlike conventional systems, use of restaurant floor space should be maximized, and opportunities should be opened to individuals preferring and/or requiring work-at-home employment. Further, the improved system and method should not require the restaurant, employee, or customers to purchase and/or learn to use any new, relatively expensive and/or complicated electronic devices.

### OBJECTS OF THE INVENTION

With the foregoing in mind, a primary object of the present invention is to provide an improved take-out ordering system and method for use at restaurants and various other types of stores.

Another object of the present invention is to provide a method of handling take-out orders which eliminates the requirement that the order-taking employee be physically present within the restaurant facility thereby providing employment opportunities for work-at-home employees and maximizing use of floor space within the restaurant.

A further object of the present invention is to provide a take-out ordering system of a format favored by customers and which can be readily implemented without significant purchases of equipment and the need for additional employee training.

### SUMMARY OF THE INVENTION

More specifically, the present invention is a method of entering take-out orders at a drive-through or other ordering station at a restaurant or store. A voice communication link is established between a personal computer of a work-at-home employee and the order-placing station. Preferably, the order-placing station is located adjacent an exterior of a restaurant/store, or alternatively within a restaurant/store, and the computer is located at an offsite location relative to the restaurant/store and the order-placing station. The voice communication link is utilized for two-way communication so that an order can be taken from a customer, such as a customer located in a vehicle adjacent the restaurant, by the offsite restaurant employee. In addition, a data communication link is established between the offsite computer and an onsite computer-based sales management system located at the restaurant utilized to facilitate food preparation, fee collection, and the recording of sales relative to food orders placed within the restaurant. Thus, the data communication link is utilized to transmit information concerning a food order from the offsite computer to the onsite computer-based sales management system so that food ordered by the customer is properly prepared and provided to the customer and fees are collected from the customer at the restaurant based on the information transmitted by the offsite restaurant employee.

Preferably, the voice and data communication links are provided via the Internet, and the offsite location is the home residence of the offsite restaurant employee. Thus, the employee utilizes his/her personal computer to connect to the Internet, and thereafter, logs onto the restaurant's on-line site to establish the voice and data communication links.

According to another aspect of the present invention, a restaurant management system for entering take-out orders is provided. The system includes an order-placing station located adjacent an exterior of a restaurant or alternatively within the restaurant, an onsite computer-based sales management system within the restaurant, and an offsite communication device and data entry terminal at a location offsite relative to the restaurant and the order-placing station. A first communication link exists between the order-placing station and the offsite communication device, and a second communication link exists between the offsite data entry terminal and the onsite computer-based sales management system. Thus, customers at or adjacent the restaurant place take-out orders by communicating via the first communication link to a person at the offsite location, and the person thereafter enters the customer's order into the onsite computer-based sales management system via the second communication link.

Preferably, the offsite communication device and data entry terminal is a personal computer which has a modem, a microphone and a speaker and which is located at the home residence of the employee. In addition, preferably the first communication link is a two-way voice communication link established over the Internet, and the second communication link is a data communication link established via the Internet.

### BRIEF DESCRIPTION OF THE DRAWINGS

The foregoing and other objects, features and advantages of the present invention should become apparent from the following description when taken in conjunction with the accompanying drawing, in which:

FIG. 1 is a view of a system for handling orders of drive through customers at a restaurant/store according to the present invention.

### DETAILED DESCRIPTION OF THE PREFERRED EMBODIMENT

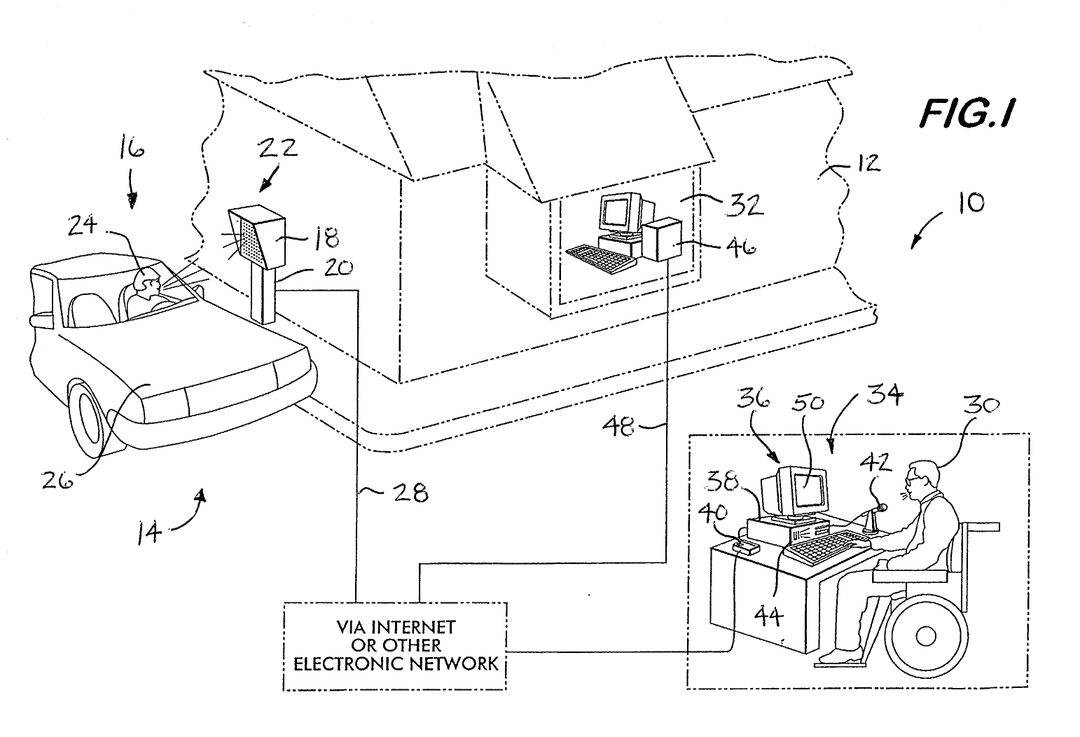

FIG. 1 conceptually illustrates the set up of an ordering system 10 according to the present invention. The system 10 is particularly useful with respect to handling take-out food orders from drive through customers at fast food restaurants. However, the ordering system 10 can also be utilized at other types of restaurants and stores having various types of ordering stations located within or exterior of the restaurant/store. The system 10 provides interaction between a customer located at the restaurant and a restaurant representative, or employee, located at an offsite location and interaction between the offsite employee and the restaurant. To this end, the customer communicates an order to the offsite employee and the offsite employee then relays the order to the restaurant by inputting appropriate information into a restaurant onsite computer-based sales management system.

According to the preferred embodiment illustrated in FIG. 1, a restaurant 12 has a drive through lane 14 which is located adjacent an exterior 16 of the restaurant 12. A talk box 18 having a microphone and speaker is mounted on a stand 20 at an order placing station 22 adjacent the drive through lane 14 and can be utilized by a customer 24 located in a vehicle 26 to place an order for take-out. To this end, the customer 24 utilizes a two-way communication link 28 accessed by the talk box 18 to communicate with a restaurant employee 30. After the order is placed, the customer 24 advances his/her vehicle 26 to a payment and food pick up window, or windows, 32 and pays for and receives the requested food items.

One important aspect of the present invention is that, unbeknownst to the customer 24, the restaurant employee 30 taking the customer's order is not physically located onsite at the restaurant 12. Rather, the employee 30 is located at an offsite location 34 which is offsite relative to the restaurant 12 and the order placing station 22. For example, the offsite location 34 may be the home residence of the employee 30 or any other location which is remote from the restaurant 12. This set up frees space at the restaurant 12 while still permitting the customer 24 to speak directly with an employee of the restaurant, as preferred by most customers.

A communication device and data entry terminal 36 is located at the offsite location 34 and enables the offsite employee 30 to communicate with the customer 24 and the restaurant 12. Preferably, the communication device and data entry terminal 36 is a personal computer 38 having a modem 40, microphone 42 and speaker 44. Alternatively, the communication device and data entry terminal 36 can be separate devices, such as a cellular phone and an electronic point of sale register (not shown). In addition, the term “personal computer” as utilized in this application refers to any computer device including, but not limited to, desktop computers, portable lap-top computers, other portable computers, hand-held computer devices, and wireless communication and/or computer devices.

A first communication link 28 is established between the offsite personal computer 38 and the order-placing station 22 so that customers can communicate orders to the offsite employee 30. According to the preferred embodiment of the present invention, this link 28 provides two-way voice communication and is established via the Internet. To this end, the personal computer 38 is loaded with a realtime audio program that permits voice communication over the Internet utilizing the microphone 42 and speaker 44 of the personal computer 32. Such software is well known in the art and is not discussed further herein. Thus, the offsite employee 30 connects the personal computer 38 to the Internet, for instance via a dial up modem connection, and then utilizes special passwords, account information, and the like to log onto the restaurant's computer system which connects the offsite employee 30 to the talk box 18 in a manner which provides two-way voice communication between the offsite employee 30 and the customer 24. Alternatively, the communication link 28 can include video, text, symbols or some other form of communication in addition to the voice communication, or in place thereof. Further, the communication link 28 can be provided via a network other than the Internet, or can be provided by a dedicated line or wireless system.

After the offsite employee 30 receives the customer's order, the order is relayed to the restaurant 12 so that the requested food is prepared in the kitchen, assembled and placed within a take-out receptacle, such as a bag or box, and is properly billed to the customer 24. The offsite employee 30 accomplishes the relay of information by entering data corresponding to the order into the personal computer 38 and then by transmitting the information to the computer-based sales management system 46 of the restaurant 12. Thus, order information transmitted by the offsite employee 30 is handled and received in a manner identical to that of an order handled by an onsite employee utilizing, for instance, an electronic point of sale (POS) register.

According to the preferred embodiment of the present invention, the offsite employee 30 transmits the order to the restaurant 12 via a data communication link 48 established over the Internet. Thus, when the offsite employee 30 logs onto the restaurant's computer system via the Internet, a data link 48 is established to the computer-based sales management system 46 of the restaurant 12 to which all the onsite POS registers are connected. Alternatively, this connection 48 can be made via a dedicated line, direct wireless connection, or network other than the Internet.

Preferably, the display on the monitor screen 50 of the offsite personal computer 38 is substantially identical to the onsite POS registers at the restaurant 12. The offsite employee 30 merely uses a mouse device, joy stick, or the like, (not shown) to point and click on the requested item or items and then hits enter to transmit the order. Thus, employee training with respect to using the work-at-home ordering system is substantially identical to employee training for onsite POS registers. Alternatively, any format can be utilized to enter data for being transmitted to the restaurant. Such formats can utilize a keyboard, touch screen, voice recognition software, or the like to make the entries.

An advantage of the present invention is that no significant additional equipment is required to implement the system. For instance, many potential employees already have access to a personal computer and to the Internet. Alternatively, the restaurant can supply an employee with a relatively inexpensive personal computer and a subscription to the Internet. In most cases, the employee may merely need to download particular software programs from the restaurant's web site to enable the above referenced communication links to be established and to provide a data entry software program for use in transmitting orders to the restaurant.

Existing onsite drive-through order-taking communication systems can be utilized as back-up systems to the system according to the present invention. For example, it is current practice for more than one onsite employee to wear a wireless headset to listen to the communications of the drive-through customer and onsite employee primarily responsible for taking orders from the drive-through customers. This is done to facilitate the preparation of orders and to provide back-up when unforseen problems occur. Thus, in the system according to the present application, one or more onsite employees can utilize the existing headsets to listen to the communication between the customer and offsite employee and take over the order handling responsibility in the event of a connection interruption or the like.

Thus, the present invention provides an improved method and system for entering food orders of drive-through customers at fast food restaurants. The use of work-at-home employees provides employment opportunities to those previously excluded from such positions. For example, individuals that cannot readily commute to and from the restaurant, or individuals that have physical limitations, can work at home and perform the necessary functions in a superior manner. The use of an offsite employee also frees additional space at the restaurant and provides other advantages.

The system and method of handling orders according to the present invention is not limited to drive through lane applications at fast food restaurants. The system 10 can be utilized at any type of restaurant/store having ordering stations. For example, some restaurants have defined parking spots, typically referred to as stalls, in which a customer parks his/her vehicle and communicates his/her order via an intercom/talk box system. Thereafter, an onsite restaurant employee, who may or may not be wearing roller skates, delivers the order to the parked vehicle. Another example includes the use of an intercom ordering system in which a talk box or like device is located at a table, or booth, within a restaurant and is utilized to communicate orders. A still further example includes a store that sells merchandise in a manner which requires the customer to communicate an order at an ordering station and in which the merchandise is then delivered from a storage warehouse to a merchandise pick-up location. The present invention can be readily utilized in all of the above referenced examples.

While a preferred method and system have been described in detail, various modifications, alterations, and changes may be made without departing from the spirit and scope of the method and system according to the present invention as defined in the appended claims.

1. A method of entering an order at a restaurant/store, comprising the steps of:
providing a first communication link between a customer located at an ordering station of the restaurant/store and a representative of the restaurant/store that is located at a location offsite relative to the restaurant/store and said ordering station so that, when said customer communicates an order, said order is communicated via said first communication link to said offsite representative; and
providing a second communication link between said offsite location and an onsite computer-based sales management system that is located within the restaurant/store and that facilitates entering, processing, and recording sales of items within the restaurant/store so that, when said customer places an order with said offsite representative, said representative thereafter transmits information concerning said order into said onsite computer-based sales management system;
whereby items ordered by the customer are readily prepared and provided to the customer and fees are collected from the customer at the restaurant/store based on the information transmitted by said offsite representative.

2. A method according to claim 1, wherein said step of providing said first communication link includes establishing a communication link between said order-placing station and a data entry terminal located at said offsite location.

3. A method according to claim 2, wherein said data entry terminal is a personal computer having a modem.

4. A method according to claim 3, wherein said first communication link includes a two-way voice communication link which permits said customer and said offsite representative to communicate verbally.

5. A method according to claim 4, further comprising the steps of establishing a connection via said modem to the Internet with said personal computer and thereafter establishing said voice communication link to said order-placing station via the Internet.

6. A method according to claim 3, wherein said step of providing a second communication link includes establishing a communication link between said onsite computer-based sales management system and said personal computer.

7. A method according to claim 6, wherein said second communication link includes a data communication link which permits said offsite representative to transmit data corresponding to said order to said onsite computer-based sales management system.

8. A method according to claim 7, further comprising the step of establishing a connection via said modem to the Internet with said personal computer and thereafter establishing said data communication link to said onsite computer-based sales management system via the Internet.

9. A method according to claim 1, wherein said customer is located within a vehicle when communicating with said offsite representative via said first communication link.

10. A method according to claim 9, wherein said order placing station is located adjacent a drive through lane of a restaurant, and the customer is located in a vehicle in said drive through lane adjacent and exterior the restaurant when communicating a drive-through take-out food order to the offsite representative via said first communication link.

11. A method of entering a drive-through take-out food order at a restaurant, comprising the steps of:
establishing a two-way voice communication link between a personal computer and a drive-through order-placing station, said drive-through order-placing station being located adjacent an exterior of the restaurant and said personal computer being located at an offsite location relative to the restaurant and said drive-through order-placing station;
receiving at said offsite location a food order from a customer located in a vehicle in a drive through lane of the restaurant, said order being received verbally via said voice communication link by a restaurant employee located at said offsite location;
establishing a data communication link between said offsite personal computer and an onsite restaurant sales-management computer system that is utilized to facilitate food preparation, fee collection, and recordation of sales relative to food orders placed within the restaurant; and
transmitting information concerning a food order from said offsite personal computer to said onsite restaurant sales-management computer system so that food ordered by the customer is properly prepared and provided to the customer and fees are collected from the customer at the drive through lane of the restaurant based on the information transmitted by said offsite restaurant employee.

12. A method according to claim 11, wherein said voice communication link and said data communication link are provided via the Internet.

13. A method according to claim 11, wherein said offsite location is the offsite restaurant employee's home residence.

14. A restaurant/store management system for entering orders, comprising:
an order-placing station located at a restaurant/store;
an onsite computer-based system within the restaurant/store for facilitating preparation, fee collection, and sales recording functions with respect to orders input into said onsite computer-based system;
an offsite communication device and data entry terminal at a location offsite relative to the restaurant/store and said order-placing station;
a first communication link between said order-placing station and said offsite communication device; and
a second communication link between said offsite data entry terminal and said onsite computer-based system;
whereby customers at the restaurant/store place orders by communicating via said first communication link to a person at said offsite location and the person thereafter enters the customer's order into said onsite computer-based system via said second communication link.

15. A system according to claim 14, wherein said offsite communication device and data entry terminal is a personal computer having a modem, a microphone and a speaker.

16. A system according to claim 15, wherein said first communication link is a two-way voice communication link.

17. A system according to claim 16, wherein said voice communication link is established via the Internet, and wherein said personal computer has a voice communication software program enabling voice communication over the Internet.

18. A system according to claim 17, wherein said second communication link is a data communication link established via the Internet.

19. A system according to claim 18, wherein said offsite location is a home residence, and wherein said personal computer functions as an electronic point of sale register.

20. A system according to claim 18, wherein said order placing station is located adjacent a drive through lane of a restaurant.
